(19) United States
(12) Patent Application Publication
(10) Pub. No.: US 2009/0042014 A1
(43) Pub. Date: Feb. 12, 2009

(54) Compressible molded component

(75) Inventors: Blake Synnestvedt, Birmingham, MI (US); Bradley McCardell, Rochester, MI (US); David Compeau, Oxford, MI (US); Eric Haglund, Clarkston, MI (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Innatech, Rochester, MI (US)

(21) Appl. No.: 11/999,924

(22) Filed: Dec. 7, 2007

Related U.S. Application Data
(60) Provisional application No. 60/963,623, filed on Aug. 6, 2007.

(51) Int. Cl. B32B 3/12

(52) U.S. Cl. 428/314.2; 264/255

(57) ABSTRACT

A compressible molded component comprises a compressible cushion member integrally formed with an additional member. The compressible cushion member is comprised of a deformable material formed by an injection molding process. During the molding process, the deformable material is injected in molten form into a core component of a mold, the core component having an array of protrusions. The array of protrusions in the mold forms an array of voids in the compressible cushion member when the component is removed from the mold. The additional member may include a skin member and/or a structural member attached to the compressible cushion member.

### CROSS-REFERENCE TO RELATED APPLICATIONS

This application claims the benefit of U.S. provisional patent application No. 60/963,623, filed Aug. 6, 2007.

### FIELD

This invention relates to the injection molding, and more particularly to a compressible component manufactured using a progressive injection molding process.

### BACKGROUND

Injection molding is a manufacturing technique for making parts from thermoplastic material. In short, injection molding is a process where molten plastic is injected into a mold. The mold comprises two or more components which, when placed together, form a cavity which is the inverse of a desired product's shape. A molten plastic material, such as, for example, acrylonitrile butadiene styrene (ABS), nylon, polypropylene, polyethylene (PE), or polyvinyl chloride (PVC) is typically injected into the cavity provided by the mold. After cooling, the plastic material hardens in the mold in the shape of the desired product. The product is then expelled from the mold and the mold may be used to produce another like product.

Many manufactured products are comprised of two or more plastic materials, and it is often desirable to produce such components as molded parts. For example, if a component calls for a rigid skeleton and a softer outer layer, it may be desirable to produce the component as a single molded part to save on manufacturing costs. In these situations, a base component comprised of a first material may be molded in a first mold. The base component may then be placed in a second mold where it is “overmolded” with a second material to form the complete product.

An alternative to overmolding is multi-shot molding. With multi-shot molding, each mold includes a core portion and at least a first cavity portion and a second cavity portion, each of which cooperate with the core portion. In order to manufacture a product using a multi-shot molding process, a first component comprised of a first material is produced using the core portion of the mold and the first cavity portion. After the base component hardens, the first cavity portion of the mold is removed and replaced by the second cavity portion, the base component remaining in the core portion of the mold such that it is covered by the second cavity portion. A second material is then injected into the second cavity portion of the mold. Accordingly, the multi-shot molding process may be used to manufacture a multi-material product without having to remove the product from the mold before it is finished. This process is often economical and efficient in producing various parts.

For various components produced in different industries it is often desirable to produce a component having a compressible portion. For example, in the automobile industry, it is desirable to provide armrests and other interior components that have a soft compressible feel. Similar soft components are desirable in the furniture industry. Many of these components are produced with a rigid molded interior skeleton that is then covered with a foam or other compressible material. A skin material, such as leather or vinyl may then be placed on top of the foam material, sandwiching the soft foam in place between the skin and the skeleton. However, this three-part arrangement of skeleton, foam, and skin is costly to produce, as the component must be assembled in order to produce a final product. Accordingly, it would be desirable to produce such components from a single molding process, such as multi-shot injection molding.

Even though it would be desirable to produce components with a compressible portion as a single molded piece, production of such components has proven difficult. Product manufactured using current multi-shot injection molding techniques result in harder than desired products for certain applications, such as furniture and automobile interior components.

Furthermore, even when a relatively soft compressible moldable material is provided, it is difficult to “overmold” such products, or produce such products with multi-shot injection molding, as the heat and pressure from molten plastic tends to melt and deform the relatively soft compressible material, resulting in a deformed product.

In view of the foregoing, it would be desirable to produce a multi-part compressible molded component. It would be further desirable if such multi-part compressible molded component could be formed by a sequential injection molding process, allowing the part to be manufactured economically and efficiently.

### SUMMARY

A compressible molded component comprises a compressible cushion member attached to an additional member. The compressible cushion member and additional member are integrally formed by a molding process. During the molding process, the compressible cushion member is molded around a core component of a mold, the core component having an array of protrusions. The array of protrusions forms an array of voids in the compressible cushion layer when the component is removed from the mold. In at least one embodiment, the array of voids are elongated in shape and defined by a center axis with the center axis of each void oriented substantially perpendicular to a primary surface portion of the additional member. In various embodiments, the arrangement, size and shape of the voids may vary.

In at least one embodiment, the compressible molded component comprises a structural layer, a compressible layer integrally formed on the structural layer, and a skin layer integrally formed on the compressible cushion layer. The compressible layer is comprised of a moldable material forming a grid-like structure. The grid of moldable material defines an array of chambers, each chamber providing a void in the compressible layer. When a force is applied, the moldable material of the compressible layer deflects into the voids, providing a cushioning effect. The structural layer is relatively rigid compared to the compressible layer to provide a solid foundation for the component.

In at least one embodiment, the compressible molded component is manufactured using a mold comprised of a core portion having an array of protrusions, and at least two corresponding cavity portions. During the molding process, the compressible layer is formed by injecting a first material into the mold such that the first material forms around the array of protrusions on the core portion. An additional layer is integrally formed adjacent to the compressible layer. After the compressible layer is integrally formed with the additional layer, the additional layer and compressible layer are removed from the mold. When the protrusions of the core portion of the mold are removed from the compressible layer, an array of cavities is formed in the compressible layer.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a top perspective view of a compressible molded component, including a cutaway section to show the interior of the component;

FIG. 2 shows a bottom perspective view of the compressible multipart molded component of FIG. 1;

FIG. 3 shows a core portion of a mold used to manufacture the compressible molded component of FIG. 1;

FIG. 4 shows the result of a first manufacturing step where a structural layer is formed in the core portion of the mold of FIG. 3;

FIG. 5 shows the result of a second manufacturing step where a compressible layer is formed over the structural layer of FIG. 4;

FIG. 6 shows the result of a third manufacturing step where a skin layer is formed over the compressible layer of FIG. 5;

FIG. 7 shows a cross-sectional view of the compressible molded component of FIG. 1 positioned in the core portion of the mold, the cross-section through a plane parallel to the top surface of the structural layer;

FIG. 8 shows a cross-sectional view of the compressible molded component in the core portion of the mold, the cross-section through line VIII-VIII of FIG. 7;

FIG. 9 shows a perspective view of an alternative embodiment of the compressible molded component of FIG. 1 where the compressible molded component is provided as an armrest;

FIG. 10 shows a perspective cutaway view of the compressible molded component of FIG. 9 along line X-X of FIG. 9;

FIG. 11A shows a top perspective view of a cushion layer of the compressible molded component of FIG. 9;

FIG. 11B shows a bottom perspective view of the cushion layer of FIG. 11A;

FIG. 12 shows a top perspective view of a structural layer of the compressible molded component of FIG. 9;

FIG. 13 shows a cross-sectional view of an alternative embodiment of the compressible molded component of FIG. 1 where the compressible molded component is an automotive seat cushion; and

FIG. 14 shows a perspective cutaway view of the circled portion of the compressible molded component of FIG. 13.

### DESCRIPTION

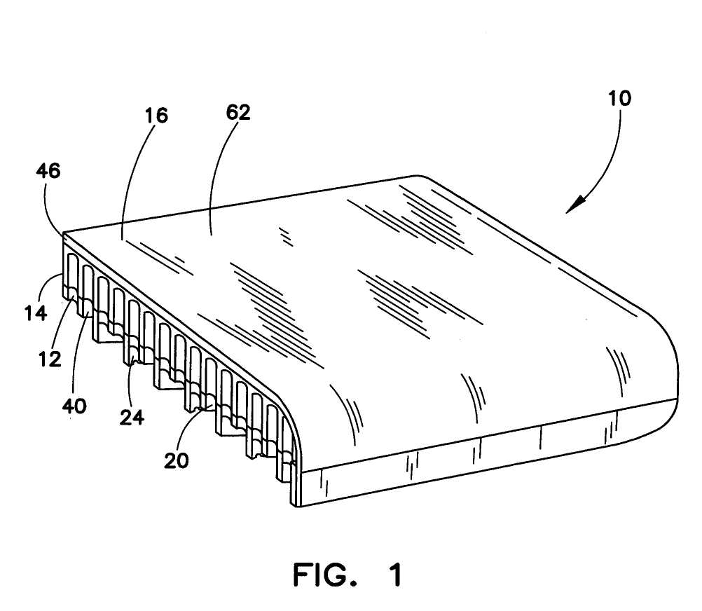

With reference to FIG. 1, a compressible molded component 10 comprises a structural layer 12, a compressible layer 14, and a skin layer 16. The structural layer 12, compressible layer 14, and skin layer 16 are each comprised of a different material, but are formed by a molding process such that the structural layer 12, compressible layer 14 and skin layer 16 are integrally formed as a single component.

The structural layer 12 provides a substrate that serves as a foundation for the component 10. The structural layer 12 is comprised of a relatively rigid moldable material. The relatively rigid moldable material may be, for example, a typical thermo-plastic material such as a polypropylene or a polyolefin.

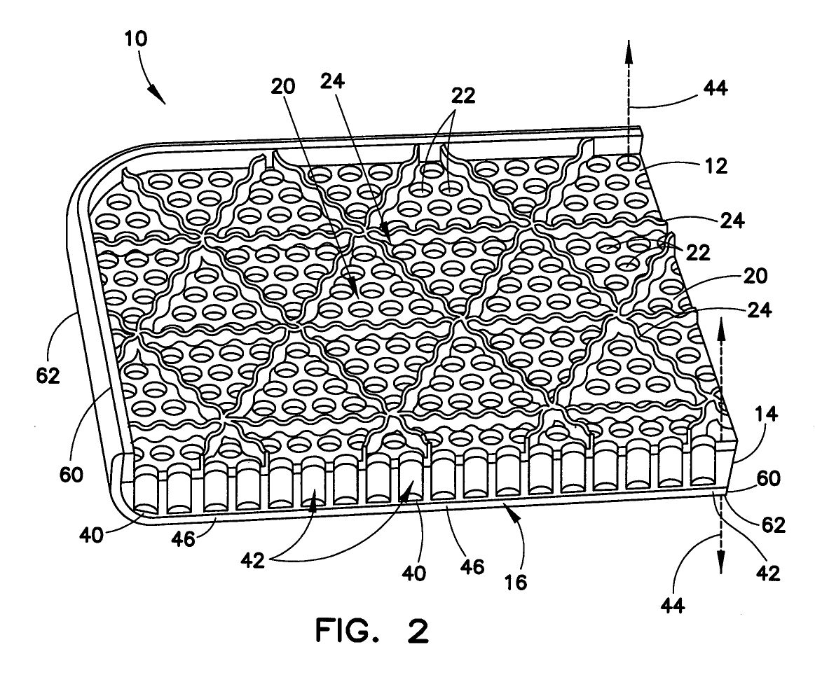

As best seen in FIG. 2, the structural layer 12 includes a plate member 20 having an array of holes 22 formed in the plate member 20. It may also include a reinforcing rib structure formed by a plurality of ribs 24 provided on a face of the plate member 20. The ribs 24 are provided on the face of the plate member 20 such that they do not overlap with the holes 22, allowing straight passage to be made through the holes. It will be recognized that in other embodiments the structural layer 12 may have differently configured ribs or may include no ribs at all, depending on the application for the component. Furthermore, it will be appreciated that the array of holes 22 may be provided in various types of arrays, such as aligned columns and rows of holes, offset columns and rows of holes (as shown in FIG. 2) or other regular groupings or arrangements.

With continued reference to FIGS. 1 and 2, the compressible layer 14 is integrally formed on the structural layer 12. The compressible layer 14 is comprised of a relatively soft deformable moldable material, such as a thermoplastic elastomer (TPE) or other flexible moldable material such a vinyl. In at least one embodiment, the relatively soft deformable moldable material has a durometer of less than 50 (shore A durometer). In other embodiments, the relatively soft deformable material may have a different durometer or may be comprised of a different material.

The compressible layer 14 is formed as a grid or matrix of moldable material. The grid of moldable material provides sidewalls 40 which define an array of air chambers 42 between the sidewalls. Each chamber 42 provides a void in the compressible layer 14. In the embodiment of FIGS. 1 and 2, the chambers 42 are substantially cylindrical in shape with a circular cross-section. Each chamber 42 is defined by elongated central axis 44 extending through the chamber 42. The elongated central axis 44 intersects the skin layer 16 and the plate member 20 of the structural layer 12 in a substantially perpendicular fashion.

The compressible layer 14 may also include a thin continuous surface that is formed opposite the structural layer 12. The thin continuous surface 46 covers the chambers 42 such that one end of each chamber is completely closed by the material that makes up the compressible layer 14.

In at least one embodiment, the chambers 42 of the compressible layer may be 2-8 mm in diameter and may be provided in the range of 1-2 mm apart. In addition, the depth of each chamber 42 from the thin surface 46 to the opposite side of the compressible layer 14 may be in the range of about 3-12 mm. It has been determined that cylindrical chambers of this size provide desired compression characteristics for the compressible layer 14 in at least one embodiment. While this is but one exemplary embodiment, it will be recognized that various other chamber shapes, sizes, configurations and arrangements are possible in addition to those disclosed herein, depending on the desired characteristics of the compressible molded component 10.

The structure of the compressible layer 14 along with its rubber-like deformable material allow the compressible layer 14 to provide a cushion member for the compressible moldable component 10. In particular, when a force is applied to the thin surface 46 of the compressible layer 14, the sidewalls 40 of the compressible layer 14 deflect into the air chambers 42, causing a cushioning effect. The rubber-like material that makes up the compressible layer is also resilient such that when the force is removed from the compressible layer, the sidewalls 40 return to their normal shape. Accordingly, the compressible layer 14 provides a cushion that is sandwiched between the structural layer 12 and the skin layer 16.

The skin layer 16 is integrally formed on the surface 46 of the compressible layer 14. The skin layer is also comprised of a relatively soft deformable moldable material, such as a TPE or other flexible moldable material, such as vinyl. In at least one embodiment, the relatively soft deformable moldable material has a durometer of greater than 70 (shore A durometer). In other embodiments, the relatively soft deformable material may have a different durometer or may be comprised of different material.

The skin layer 16 is provided as a cover material for the compressible molded component 10. The skin layer includes an inner surface 60 that contacts and is integrally formed with the surface 46 of the compressible layer. The skin layer also includes an outer surface 62 that provides an exterior surface for the molded component 10.

The skin layer 16 may provide a continuous surface that provides an aesthetically pleasing look and/or feel to the component, depending upon the intended use of the component 10. For example, if the compressible molded component 10 is designed for use as an armrest, such as an automobile armrest or furniture armrest, the skin layer 16 may be configured to resemble a leather or vinyl material. The outer surface 62 of the skin layer 16 may be textured or smooth in look and/or feel, depending on the intended use of the component 10. Furthermore, different combinations of materials and designs for the both the skin layer 16 and compressible layer 14 will produce different compressible molded components 10, each having a different compliancy and overall cushion effect.

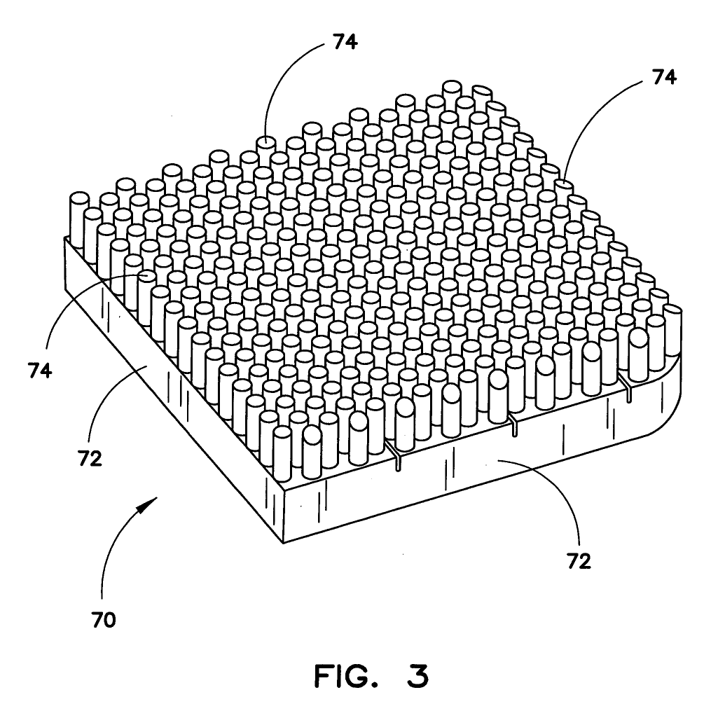

A multi-shot injection molding process is used to produce the above-described compressible molded component 10 having multiple integrally formed layers. An exemplary core portion of a multi-shot mold used to produce the compressible molded component 10 is shown in FIG. 3. The core portion 70 is comprised of a metal material such as steel. The core portion 70 includes a bottom slab 72 with a plurality of protrusions in the form of substantially cylindrical posts 74 or other elongated members extending from the slab 72. The posts can be arranged in an array structure with a plurality of post rows, each row being slightly offset from the previous row. In any event, as explained in further detail below, the structure of the posts 74 is configured to produce the desired structure for the array of chambers 42 in the compressible layer 14 of the component 10.

With reference now to FIGS. 4-6, the compressible molded component 10 may be produced using a three step molding process. In the first step of the process, a first cavity portion (not shown) is engaged with the core portion 70 of the mold, and the molten material used to form the structural layer 12 is injected into the core. The molten material flows around the posts 74 and into rib forming cavities. This provides for the holes 22 and ribs eventually found in the structural layer. After the material used to form the structural layer cools and hardens, the first cavity portion is removed from the mold, resulting in the structural layer 12 formed upon the core portion 70, as shown in FIG. 4.

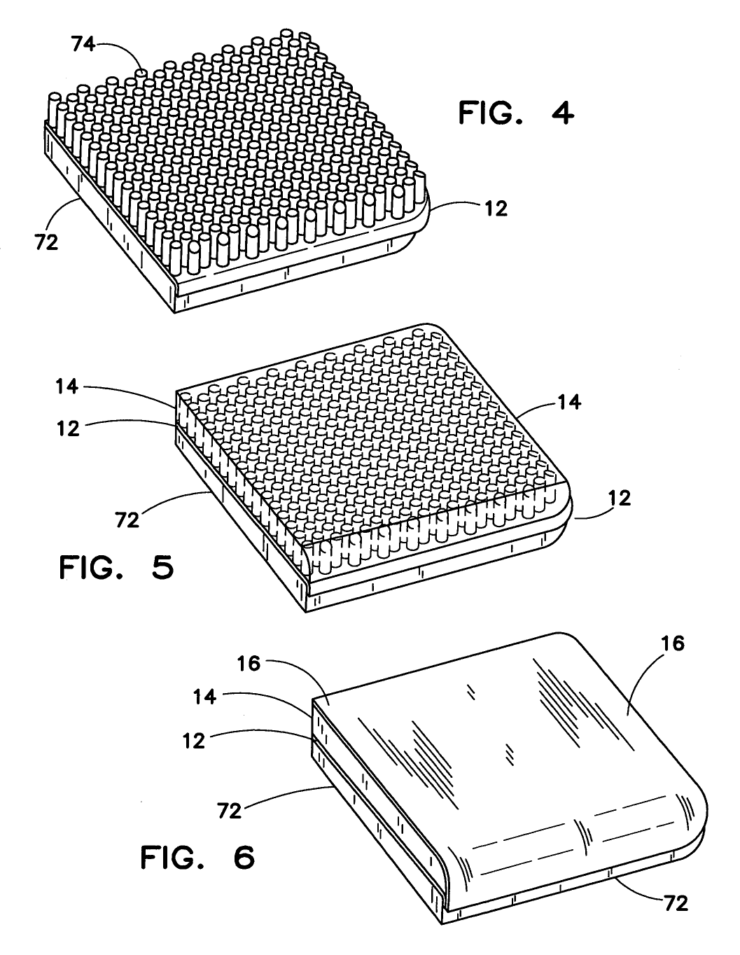

In the second step of the process, a second cavity portion (not shown) is engaged with the core portion 70 of the mold, and the molten material used to form the compressible layer 14 (e.g., a relatively soft TPE) is injected into the core. As shown in FIG. 5, the molten material flows onto the structural layer 12 and around the exposed portions of the posts 74 until it completely covers the posts 74. In other embodiments, the molten material forming the compressible layer 14 does not cover the posts 74. After the material used to form the compressible layer 14 cools and hardens, the second cavity portion is removed from the mold, resulting in the compressible layer 14 being integrally formed upon the structural layer 12, as shown in FIG. 5.

In the third step of the process, a third cavity portion (not shown) is engaged with the core portion 70 of the mold, and the molten material used to form the skin layer 16 (e.g., a harder TPE than the compressible layer) is injected into the mold. As shown in FIG. 6, the molten material flows onto the compressible layer 14 and covers the compressible layer. The relatively soft material of the compressible layer 14 is not destroyed by the mold pressure and heat of the molten material forming the skin layer, as the posts 74 of the core portion 70 of the mold stabilize the material forming the compressible layer 14. After the material used to form the skin layer 16 cools and hardens, the third cavity portion is removed from the mold, resulting in the skin layer 16 being integrally formed upon the compressible layer 14, as shown in FIG. 6.

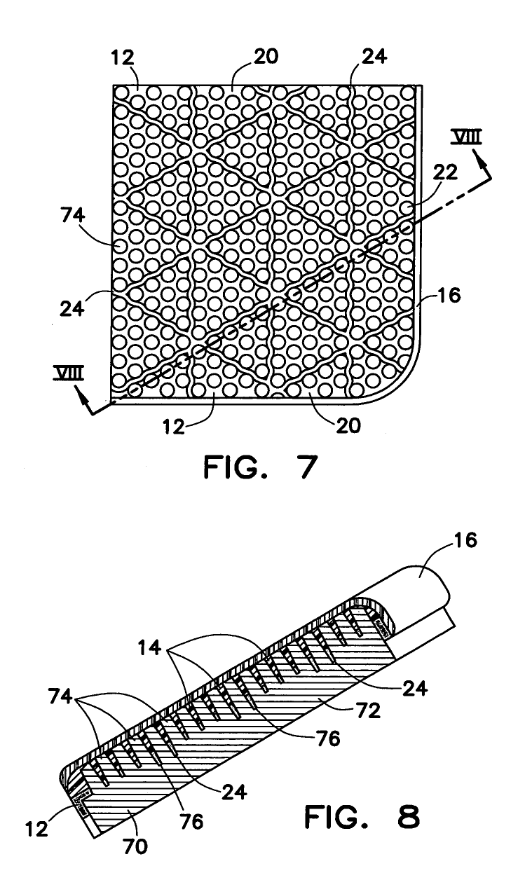

FIGS. 7 and 8 provided cross-sectional views of the compressible molded component 10 in its completed form before it is removed from the core portion 70 of the mold. As shown in FIG. 7, the posts 74 extend through the structural layer 12, thus forming holes in the structural layer. As shown in FIG. 8, the core portion 70 of the mold may include deep grooves 76 that form the ribs 24 of the structural layer 12. As also shown in FIG. 8, the posts 74 of the core portion 70 extend through a substantial portion of the compressible layer 14 during the molding process in order to form the chambers 42 in the compressible layer.

The above-described embodiment discloses a three part compressible molded component where the compressible layer 14 is sandwiched between the structural layer 12 and the skin layer 16. However, in other embodiments, the compressible layer 14 may be integrally formed in conjunction with only one additional layer, or with three or more additional layers. For example, the compressible layer could be integrally formed to a single additional layer providing an additional layer (e.g., either structural layer 12 or skin layer 16) using the core portion 70 of the mold shown in FIG. 7. In such embodiment, the compressible layer 14 could be formed upon the additional layer, or the additional layer could be formed on the compressible layer, without a third layer. As an example of an embodiment where three or more additional layers are integrally formed with the compressible layer 14, the compressible layer 14 could be formed on the structural layer 12, and two different types of skin layers 16 could be formed on the compressible layer, thus providing different skin textures on different portions of the compressible layer.

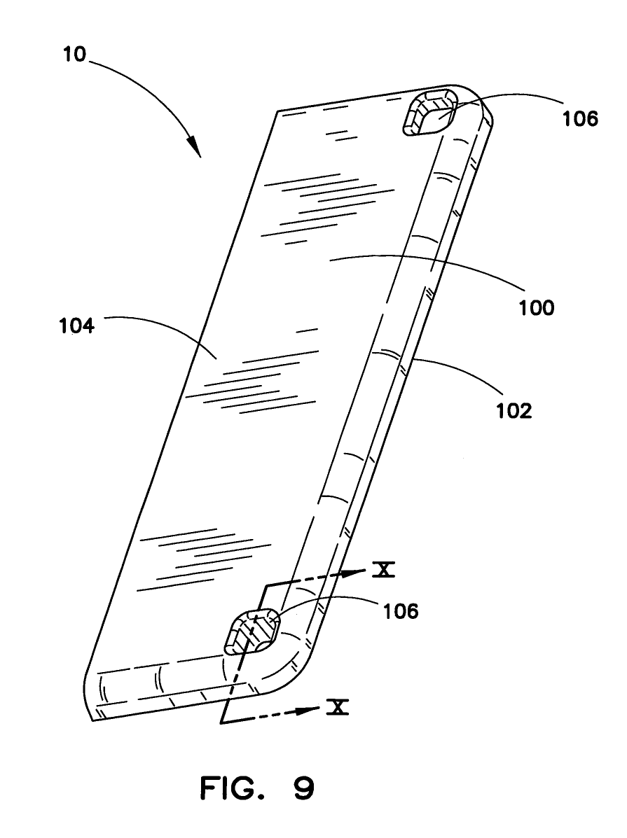

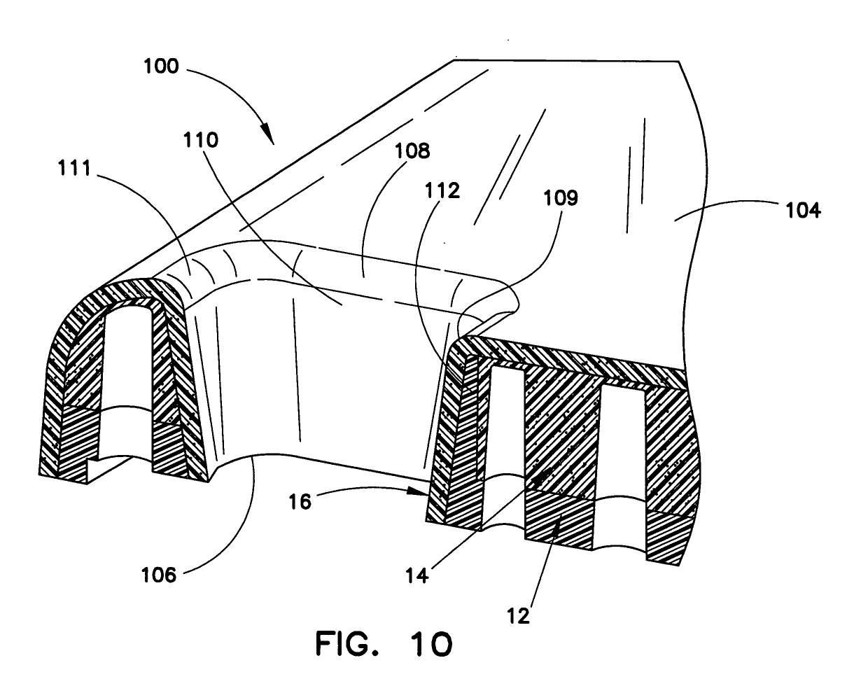

With reference now to FIGS. 9-12, an alternative embodiment of the compressible molded component 10 is shown in the form of an armrest 100. The armrest 100 is configured for use in an automobile interior, for use with furniture, or for use in numerous other applications, including, for example, use as automotive seat cushions or automotive trim panels. As shown in FIG. 9, the armrest 100 is covered by a skin layer 16. The skin layer 16 covers the side portion 102 of the armrest 100 as well as the top portion 104 which provides the primary exterior surface portion of the armrest. Depressions 106 can be seen in the top portion 104. These depressions 106 may be provided for aesthetic purposes and/or functional purposes, depending on the particular application. For example, the depressions 106 may provide functional features such as access to other interior components in an automobile or a means for connecting the armrest to other components. At the same time, the depressions have an aesthetic quality because of the smooth transition in the skin layer 16 when the surface of the armrest changes direction at the depression 106.

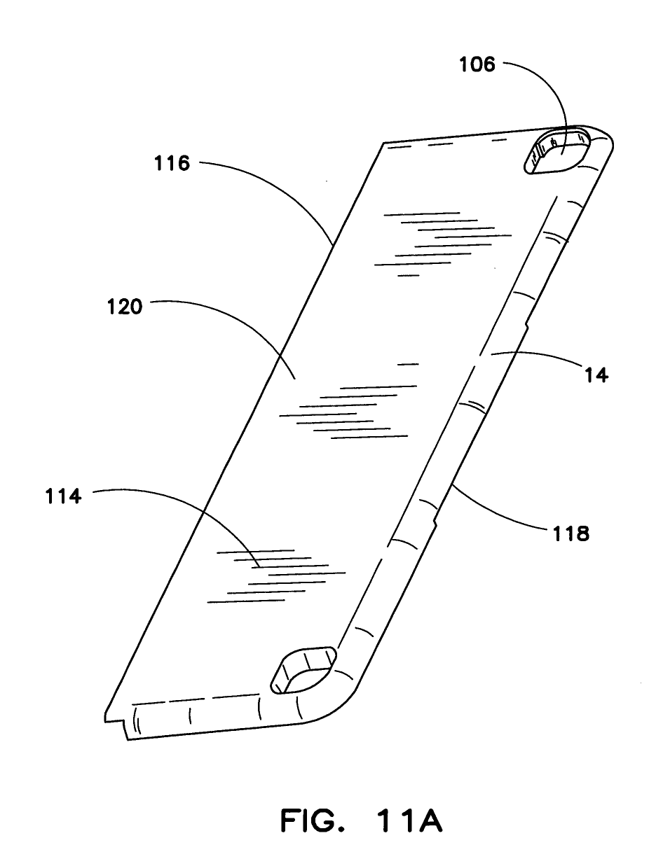

FIG. 10 shows an enlarged cutaway view at one of the depressions 106 of the armrest 100 of FIG. 9. The armrest 100 includes a flexible skin layer 16, a compressible layer 14, and a relatively rigid structural layer 12. The skin layer 16 is integrally formed over the compressible layer 14 and the structural layer 12. Accordingly, the skin layer 16 extends down into the depression 106 and covers the compressible layer 14 and the structural layer 12 in the depression 106. Since the skin layer 16 is formed on the compressible layer 14 and the structural layer 12 during a multi-shot molding process, the skin layer 16 is able to provide a smooth rounded edge 108 from the top portion 104 of the armrest 100 to the sidewalls 110 of the depression 106. This smooth rounded edge 108 in the skin layer 16 does not include undesirable puckers and folds around the depression 106 as might be seen if a fabric material were used to cover the compressible layer 14.

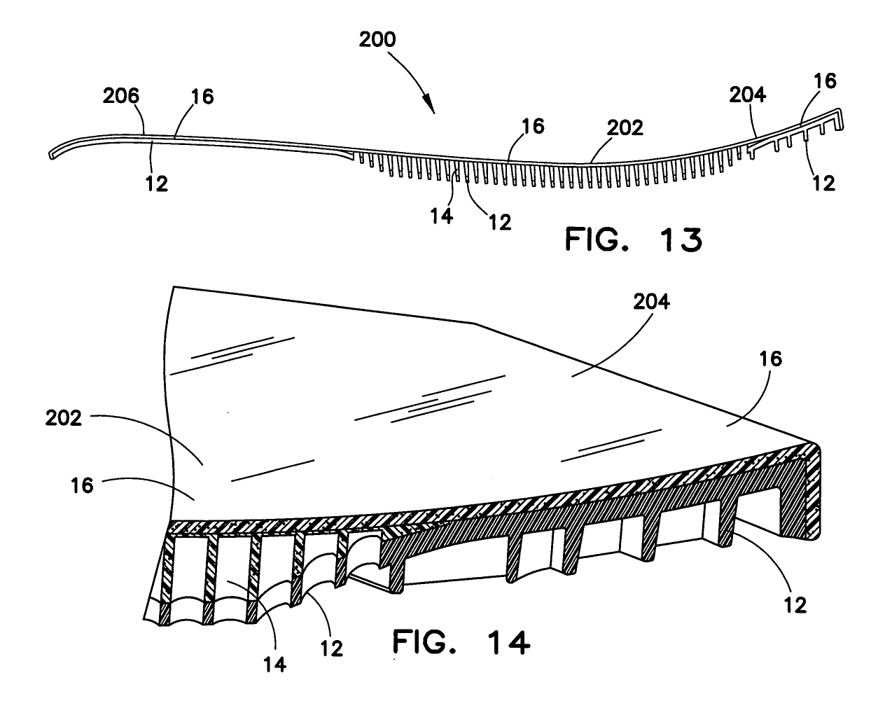

As shown in FIG. 10, in various embodiments of the compressible molded component, portions of the skin layer 16 may be integrally formed adjacent to the structural layer 12 rather than adjacent to the compressible layer 14. For example at rounded edge 109 of the depression 106, the structural layer includes a rib 112 that extends up the sidewall 110 of the depression such that the rib 112 is provided between the skin layer 16 and the compressible layer 14. This rib allows the armrest to be designed with certain portions that are less cushioned than other portions at the skin layer 16. Thus, a person providing a force against the armrest 100 would encounter a non-deformable, rigid feel at corner 109 of the depression 106, and a deformable, more cushioned feel at the opposite corner 111 of the depression 106. Another exemplary embodiment where the skin layer 16 of the compressible molded component 10 is provided in direct contact with the structural layer 12 is shown in FIGS. 13 and 14, which figures are described in further detail below.

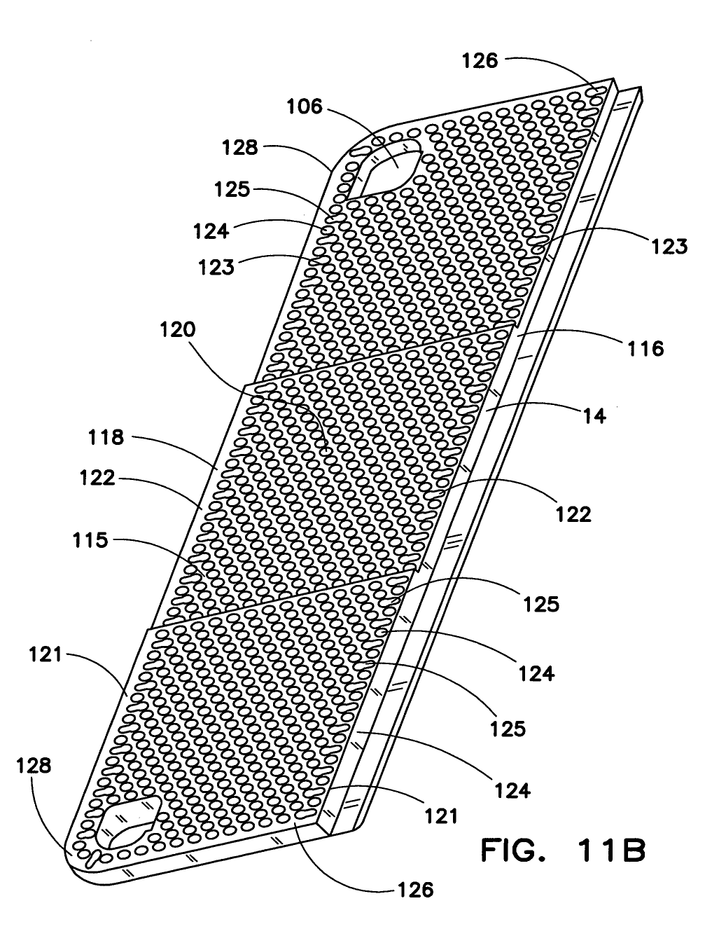

With reference now to FIG. 11A a top perspective view of the compressible layer 14 of the armrest 100 of FIG. 9 is shown. As represented in this figure, the upper surface 114 of the compressible layer is generally smooth and flat. It is this upper surface 114 of the compressible layer that contacts the skin layer 16.

FIG. 11B shows a bottom perspective view of the compressible layer 14. The bottom portion 115 of the compressible layer 14 shows the array of chambers 42 formed within the compressible layer. In this embodiment, the chambers 42 extend most of the way through the compressible layer, but do not extend to the upper surface.

In the embodiment of FIG. 11B, the compressible layer 14 includes three sections 121, 122, and 123, each section having a different thickness. In particular, the compressible layer 14 is thickest from the top portion 114 to the bottom portion 115 at section 121. A step in the thickness of the compressible layer 14 is made between sections 121 and 122, such that the compressible layer 14 is less thick at section 122 than at section 121. Another step in the thickness of the compressible layer is made between sections 122 and 123, the compressible layer 14 being thicker in section 122 than in section 123. By varying the thickness of the compressible layer 14 in different sections of the armrest 100, the cushioning effect of the armrest changes from section to section. Accordingly, a human pressing against the skin of the armrest will experience a greater cushion effect when pressing against section 121 than when pressing against section 122 or 123. With the ability to vary the thickness of the compressible layer 14, the designer of the molded component is provided with an additional tool for manipulating the cushion effect at various locations on the component.

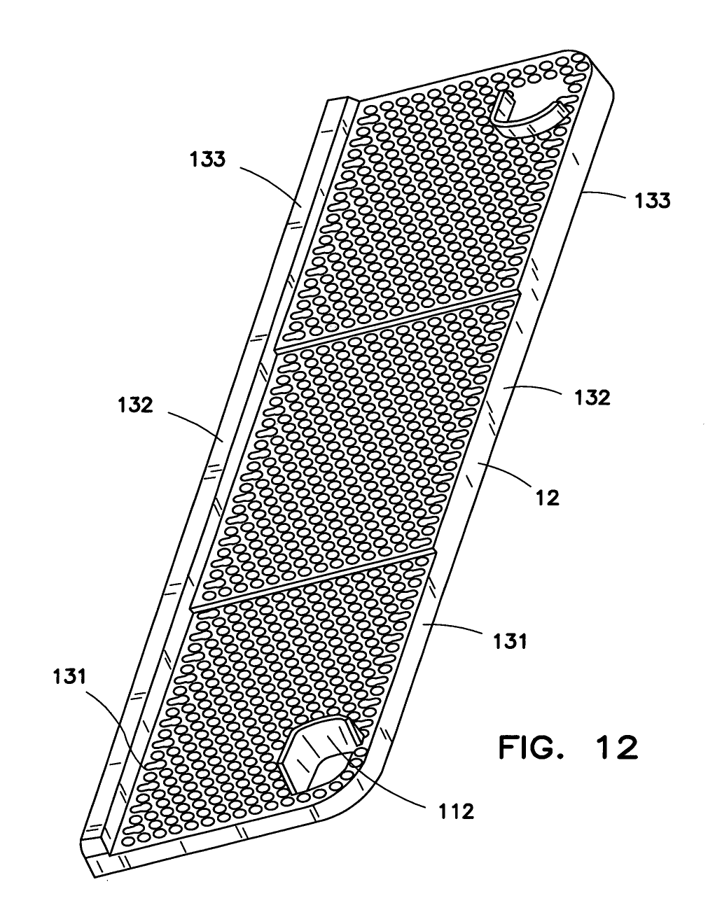

FIG. 12 shows the structural layer 12 of the armrest 100. Like the compressible layer 14, the structural layer 12 also includes sections 131, 132, 133 of different thicknesses. These sections are designed to compliment sections 121, 122, and 123 of the compressible layer 14, such that the armrest will have a generally flat, planar bottom surface, which may facilitate attachment of the armrest to its application, such as the interior of an automobile. In the structural layer, section 133 is thicker than section 132, and section 132 is thicker than section 131. Accordingly, section 131 of the structural layer is provided adjacent to section 121 of the compressible layer, section 132 is provided adjacent to section 122, and section 133 is provided adjacent to section 123.

Returning to FIG. 11B, another feature of the molded compressible component allows the cushioning effect to be varied in different portions of the component. In particular, the number, size and/or shape of the chambers 42 may be changed from section to section in order to provide more or less cushioning. Larger chambers and/or greater numbers of chambers (i.e., a greater “density” chambers) generally provide a greater cushioning effect. Smaller and/or fewer chambers (less “density”) generally provide less cushioning. The size, shape and density of the chambers may be varied in different portions of the cushion layer to provide different cushioning effects in different portions of the compressible molded component 10.

In the embodiment of FIG. 11B, the armrest 100 includes a greater density of chambers along the elongated edges 116, 118 in order to provide more cushioning along the elongated edges than that provided in the central portion 120 of the armrest 100. In addition to a greater density of chambers, the size and shape of many chambers provided at the elongated edges 116, 118 is different from the size and shape of the chambers 42 in the central portion 120 of the cushion layer 14. In particular, as shown in FIG. 11B, the edge-most rows 126 and 128 of chambers include extra chambers 125 having a cross-section that resembles a snowman or two overlapping circles. The shape of these chambers 125 is such that the chambers 125 extend into the rows adjacent to the edge-most rows 126, 128 and provide the chambers 42 for those adjacent rows. Standard chambers 124 are also found in the edge-most rows 126, 128 as well as in the central portion 120 of the armrest. These standard chambers 124 are smaller in size than the extra chambers 125 and have a circular cross-section.

With reference now to FIGS. 13 and 14, an alternative embodiment of the compressible molded component is shown in the form of an automotive seat cushion 200. In this embodiment, the thickness of the compressible layer is different at different locations in order to provide a different cushioning effect at the different locations. FIG. 13 shows a cross-section of the seat cushion 200. As can be seen in FIG. 13, the compressible layer is provided only in a central portion 202 of the seat cushion 200. The compressible layer is not provided at the end portions 204, 206 of the seat cushion. Instead, the skin layer 16 is integrally formed with the structural layer 12 at the end portions 204, 206 of the seat cushion. By contrast, at the central portion 202, the compressible layer is sandwiched between the skin layer 16 and the structural layer 12.

As best seen in FIG. 14, at the edges of the central portion 202, the compressible layer 14 tapers off as the thickness of the compressible layer diminishes until it is absent in the end portion 204. Because of this taper feature in the compressible layer 14 the cushioning effect provided by the compressible layer 14 gradually diminishes over the tapered area and a human pressing against the seat cushion 200 will feel a smooth transition in the cushioning effect provided by the seat cushion when moving from the central portion 202 to the end portion 204.

Although the present invention has been described with respect to certain preferred embodiments, it will be appreciated by those of skill in the art that other implementations and adaptations are possible, such as those described in the preceding paragraph. Moreover, there are advantages to individual advancements described herein that may be obtained without incorporating other aspects described above. Therefore, the spirit and scope of any claims related to this application should not be limited to the description of the preferred embodiments contained herein.

What is claimed is:

1. A compressible molded component comprising:
a compressible cushion layer comprising an array of voids; and
a second layer adjacent to the compressible cushion layer;
the compressible cushion layer and the second layer integrally formed by a molding process wherein the compressible cushion layer is molded around a core component of a mold having an array of protrusions, the array of protrusions forming the array of voids in the compressible cushion layer when the compressible molded component is removed from the mold.

2. The compressible molded component of claim 1 wherein the second layer provides an outer covering for the compressible molded component, the second layer including a primary exterior surface portion.

3. The compressible molded component of claim 2 wherein each void in the array of voids in the compressible cushion layer is elongated in shape and extends along an axis, the axis of each void oriented substantially perpendicular to the primary exterior surface portion of the second layer.

4. The compressible molded component of claim 1 wherein the second layer provides a structural layer for the compressible molded component, the structural layer being relatively rigid compared to the compressible cushion layer.

5. The compressible molded component of claim 1 wherein the molding process is a multi-shot molding process.

6. A compressible molded component comprising:
a structural layer;
a compressible layer integrally formed: on the structural layer, the compressible layer comprised of a resilient moldable material defining an array of chambers, the resilient moldable material adapted to deflect into the voids of the compressible layer when a deforming force is applied to the compressible layer, wherein the structural layer is relatively rigid compared to the compressible layer; and
a skin layer integrally formed on the compressible layer.

7. The compressible molded component of claim 6 wherein the compressible molded component is formed by a multi-shot molding process wherein the compressible layer is molded around a core component of a mold having an array of protrusions, the array of protrusions forming the array of chambers in the compressible layer when the compressible molded component is removed from the mold.

8. The compressible molded component of claim 6 wherein the deforming force is a force having a magnitude within a range that may be provided by a human pressing against the compressible molded component.

9. The compressible molded component of claim 8 wherein the resilient moldable material has a shore A durometer of less than or equal to 50.

10. The compressible molded component of claim 6 wherein the skin layer is a flexible layer that substantially covers the compressible layer.

11. The compressible molded component of claim 6 wherein the structural layer includes an array of holes wherein each hole in the array of holes is aligned with one of the chambers in the array of chambers of the structural layer.

12. The compressible molded component of claim 6 wherein each chamber in the array of chambers is in the range of about 2 and 8 mm in diameter and the chambers are provided about 1 to 2 mm apart.

13. The compressible molded component of claim 6 wherein the compressible layer is sandwiched between the structural layer and the skin layer.

14. The compressible molded component of claim 6 wherein the compressible molded component is an automotive interior component.

15. The compressible molded component of claim 6 wherein the compressible molded component is a furniture cushion component.

16. The compressible molded component of claim 6 wherein the thickness of the compressible layer varies within the compressible molded component.

17. The compressible molded component of claim 16 wherein the compressible layer is sandwiched between the structural layer and the skin layer in a first portion of the compressible molded component and wherein the skin layer is integrally formed with the structural layer in a second portion of the compressible molded component.

18. The compressible molded component of claim 6 wherein the array of chambers includes chambers of at least two different shapes.

19. A method of making a compressible molded component comprising the steps of:
providing a mold comprised of a core portion and at least two corresponding cavity portions, the core portion having an array of protrusions;
forming a compressible layer by injecting a first material into the mold such that the first material forms around the array of protrusions on the core portion;
integrally forming an additional layer adjacent to the compressible layer;
removing the additional layer and the compressible layer from the mold, wherein when the protrusions of the core portion of the mold are removed from the compressible layer, an array of cavities is formed in the compressible layer.

20. The method of claim 19 wherein the compressible layer is formed in the mold using the core portion and a first of the at least two corresponding cavity portions.

21. The method of claim 20 wherein the additional layer is formed in the mold using a second of the at least two corresponding cavity portions, and wherein the step of integrally forming the additional layer comprises injecting a second material into the mold.

22. The method of claim 19 wherein the additional layer is a first additional layer, the method further comprising the step of integrally forming a second additional layer adjacent to the compressible layer by injecting a third material into the mold, and wherein the second additional layer is formed using a third of the at least two corresponding cavity portions.
